(19) United States
(12) Patent Application Publication
(10) Pub. No.: US 2018/0264636 A1
(43) Pub. Date: Sep. 20, 2018

(54) Hand-held Power Tool

(71) Applicant: Hilti Aktiengesellschaft, Schaan (LI)

(72) Inventor: Steffen Geiger, Muenchen (DE)

(73) Assignee: Hilti Aktiengesellschaft, Schaan (LI)

(21) Appl. No.: 15/537,229

(22) PCT Filed: Dec. 15, 2015
(86) PCT No.: PCT/EP2015/079698

§ 371 Date: Jun. 16, 2017

(30) Foreign Application Priority Data
Dec. 18, 2014 (EP) 14198722.2

(51) Int. Cl. B25D 17/06; B25D 17/02; B25D 11/12

(52) U.S. Cl. CPC B25D 17/06; B25D 17/02; B25D 11/125; B25D 2250/181; B25D 2217/0023; B25D 2250/345; B25D 2250/371; B25D 2250/265

(57) ABSTRACT

A power tool is disclosed. The power tool has a pneumatic percussion mechanism with a percussion element guided on a working axis and a percussion surface pointing in a percussion direction, an exciter piston driven by a motor, and a pneumatic chamber formed between the exciter piston and the percussion element. The percussion element has a first partial body forming the percussion surface, a second partial body, and a spring element. The first partial body is moveable along the working axis relative to the second partial body. The second partial body has an abutment surface pointing in the percussion direction. The first partial body has an impact surface opposite the abutment surface. The spring element drives the first partial body relative to the second partial body in the percussion direction into a starting position in which the abutment surface is separated from the impact surface by a gap.

This application claims the priority of International Application No. PCT/EP2015/079698, filed Dec. 15, 2015, and European Patent Document No. 14198722.2, filed Dec. 18, 2014, the disclosures of which are expressly incorporated by reference herein.

### BACKGROUND AND SUMMARY OF THE INVENTION

The present invention relates to a hand-held power tool having a pneumatic percussion mechanism driven by a motor.

US 2002 003045 A discloses a generic hand-held power tool with a percussion mechanism driven by a motor for drills and chisels. A motor moves an exciter piston forward and backward in a guide tube along a working axis. A percussion element is located in the guide tube. A closed pneumatic chamber is between the exciter and the percussion element; the chamber is periodically compressed and decompressed by the exciter. The percussion element is accelerated by a built-up pressure difference with respect to the environment and hereby coupled to the movement of the exciter. The percussion element impacts an anvil in the percussion direction, the anvil transferring the impact to a tool.

The capacity provided by the motor should be converted as efficiently as possible into chiseling capacity for the tool.

The power tool according to the invention has a tool holder for holding a chiseling tool on a working axis, a motor and a pneumatic percussion mechanism driven by the motor. The percussion mechanism has a percussion element guided on the working axis and provided with a percussion surface pointing in the percussion direction, an exciter piston driven by the motor and a pneumatic chamber formed between the exciter piston and the percussion element for coupling the percussion element to the movement of the exciter piston. The percussion element has a first partial body forming the percussion surface, a second partial body and a spring element. The first partial body is movable along the working axis relative to the second partial body. The second partial body has an abutment surface pointing in the percussion direction. The first partial body has an impact surface opposite the abutment surface for receiving an impact of the second partial body on the first partial body. The spring element drives the first partial body relative to the second partial body in the percussion direction into a starting position in which the abutment surface is separated from the impact surface by a gap.

The percussion element impacts an anvil or the tool with the first partial body. The second partial body is still moved in the percussion direction until the gap is closed and only then impacts the first partial body which transfers the impact indirectly to the tool. The impact of the second partial body takes place in a delayed manner with respect to the first partial body whereby the kinetic energy of the percussion element is transferred via an extended impact duration. The efficiency can be hereby increased in particular in the case of heavy percussion mechanisms.

One configuration provides for the gap to have a width of between 0.3 mm to 1.5 mm. The delay with which the second partial body impacts the first partial body, after the first partial body impacts the tool or an anvil, is preferably between 25 μs and 125 μs. A shorter delay exhibits no effect. A longer delay leads to a very ineffective double impact since the first partial body has already begun its return movement in the meantime.

One configuration provides for the first partial body and the second partial body to each have a proportion of at least 25% of the mass of the percussion mechanism. The mass ratio of the first partial body to the second partial body is preferably in the range between 1:2 to 2:1, particularly preferably 1:1.5 to 1.5:1. The extension of the impact takes place as evenly as possible over time.

The following description explains the invention based on exemplary embodiments and figures.

### BRIEF DESCRIPTION OF THE DRAWINGS

FIG. 1 illustrates a jackhammer;

FIG. 2 illustrates a percussion mechanism;

FIG. 3 illustrates a percussion mechanism; and

FIG. 4 illustrates an extract from the percussion mechanism of FIG. 3.

### DETAILED DESCRIPTION OF THE DRAWINGS

Identical or functionally-identical elements are indicated in the figures with the same reference numerals, unless otherwise indicated. A front side of a component designates, in the application, the side facing the tool, i.e., in the percussion direction; a rear side of the component designates the side facing away from the tool, i.e., pointing counter to the percussion direction.

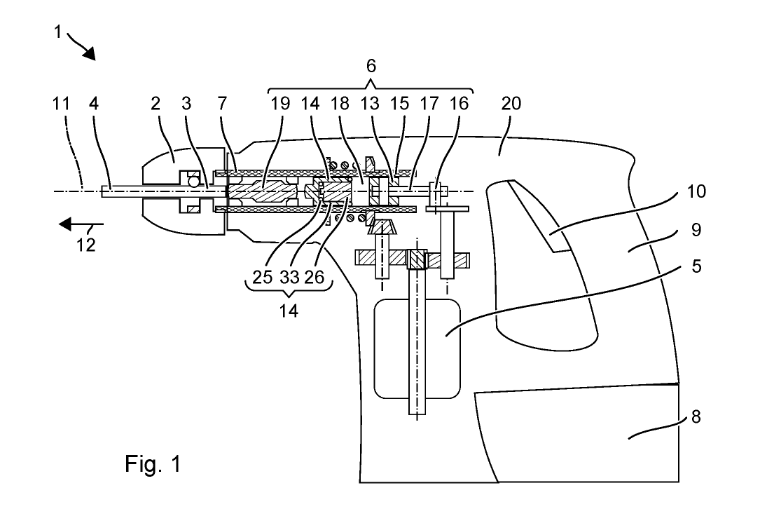

FIG. 1 schematically shows a jackhammer 1 as an example of a chiseling hand-held power tool. The jackhammer 1 has a tool holder 2 into which a shaft end 3 of a tool, e.g., of the drill 4, can be inserted. A motor 5 forms a primary drive of the jackhammer 1, the motor drives a percussion mechanism 6 and a drive shaft 7. A battery pack 8 or a power cable supply the motor 5 with power. A user can carry the jackhammer 1 by means of a handgrip 9 and operate the jackhammer 1 by means of a system switch 10. During operation, the jackhammer 1 continuously turns the drill 4 around a working axis 11 and can in this case impact the drill 4 in the percussion direction 12 along the working axis 11 into a substrate.

The percussion mechanism 6 is a pneumatic percussion mechanism 6. An exciter piston 13 and a percussion element 14 are moveably guided in a guide tube 15 in the percussion mechanism 6 along the working axis 11. The exciter piston 13 is coupled to the motor 5 via an eccentric 16 and forced into a periodic, linear movement. A connecting rod 17 connects the eccentric 16 to the exciter piston 13. An air spring formed by a pneumatic chamber 18 between the exciter piston 13 and the percussion element 14 couples a movement of the percussion element 14 to the movement of the exciter piston 13. The percussion element 14 can directly impact a rear end of the drill 4 or indirectly transfer a part of its impulse to the drill 4 via a substantially idle anvil 19. The percussion mechanism 6 and preferably the additional drive components are arranged inside a machine housing 20.

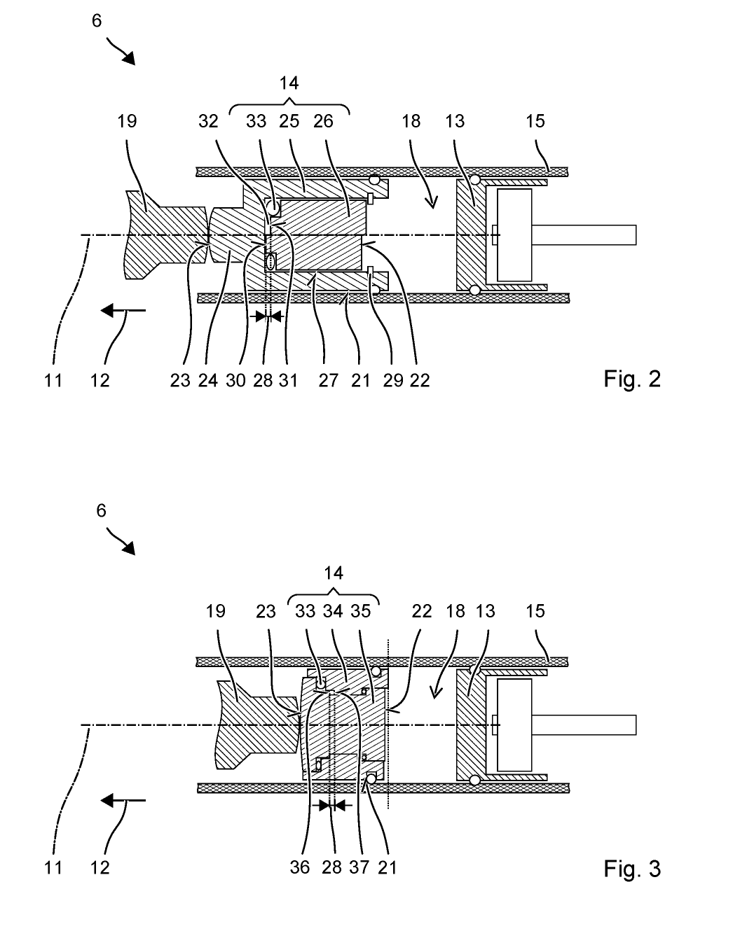

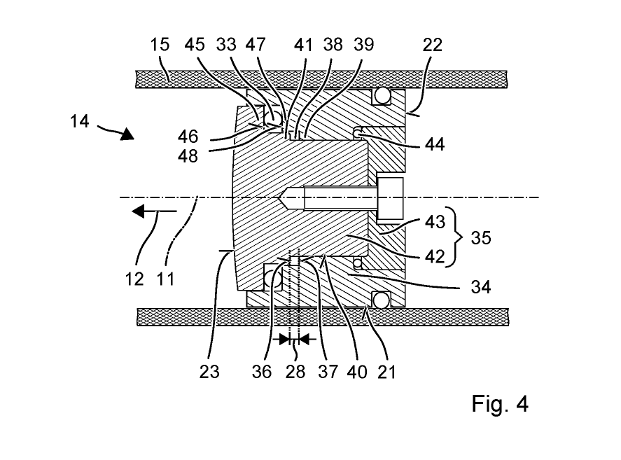

Details of the percussion mechanism 6 are illustrated in FIG. 2. The percussion element 14 has a cylindrical sliding surface 21 which abuts radially on the guide tube 15. The percussion element 14 is guided by its sliding surface 21 on the inner surface of the guide tube 15 along the working axis 11. A sealing ring can be inserted into the sliding surface 21 on the side of the percussion element 14 facing away from the tool in order to improve the air-tight closure of the percussion element 14 with the guide tube 15. A rear side 22 of the percussion element 14 is facing the exciter piston 13. The rear side 22 closes the pneumatic chamber 18 in the percussion direction 12. A front side of the percussion element 14 forms the percussion surface 23 which impacts the anvil 19 or the tool 4. The exemplary percussion element 14 has a ram 24 forming the percussion side; the diameter of the ram is smaller than the diameter of the cylindrical sliding surface 21. The percussion surface 23 can be convexly curved. The percussion surface 23 is preferably rotationally symmetrical to the working axis 11.

The percussion element 14 has a pot-shaped sleeve 25 and a core 26 inserted into the sleeve 25. The sleeve 25 forms the sliding surface 21 of the percussion element 14. The exemplary sleeve 25 also forms the percussion surface 23 of the percussion element 14. The sleeve 25 is closed at the front side. The sleeve 25 can be provided with the ram 24. The sleeve 25 has a cylindrical or prismatic cavity whose inner surface 27 is orientated parallel to the working axis 11. The cavity is preferably coaxial to the working axis 11. The exemplary cavity is open to the rear side of the sleeve 25. The core 26 is inserted into the cavity. A cross-section of the core 26 is complementary to the cross-section of the cavity. The core 26 is guided movably on the inner surface 27 of the cavity in the cavity along the working axis 11. The core 26 preferably has only one sliding clearance in the radial direction. The percussion element 14 is preferably formed rotationally symmetrical to the working axis 11. The sleeve 25 and the core 26 are arranged coaxially corresponding to each other.

The core 26 is enclosed in the percussion element 14 along the working axis 11. The axial movement of the core 26 is delimited by the enclosure to a course 28. The course of the core 26 is delimited by a rear stop counter to the percussion direction 12. The sleeve 25 forms the rear stop by means of an exemplary snap ring 29. The snap ring 29 is inserted into the inner surface 27 of the sleeve 25 close to the rear side 22. The core 26 comes to abuts with its rear side on the snap ring 29. The rear stop can alternatively be formed by pins, splints, screwed elements which are inserted immovably into the sleeve 25. The core 26 abuts in its starting position on the rear stop (see upper half of image of FIG. 2).

The course 28 is delimited in the percussion direction 12 by an impact surface 30 of the sleeve 25. The impact surface 30 pointing counter to the percussion direction 12 can for example be formed by an inner surface of the closed front side of the sleeve 25. The impact surface 30 and the percussion surface 23 are preferably formed by a monolithic body, i.e., by a body without joining areas. The core 26 has an abutment surface 31 pointing in the percussion direction 12. The abutment surface 31 can impact the impact surface 30 (see lower half of image of FIG. 2). The exemplary abutment surface 31 is provided on the front side of the core 26. The abutment surface 31 can be smaller than the cross-section of the core 26. The exemplary core 26 has a ram forming the abutment surface 31 on its front side.

The impact surface 30 of the sleeve 25 is located inside the percussion element 14. The impact surface 30 is preferably rotationally symmetrical to the working axis 11. The impact surface 30 can be located as illustrated on the working axis 11 or be formed by a circular shoulder on the inner surface 27. The abutment surface 31 of the core 26 is configured complementary to the impact surface 30.

The core 26 is distanced in its starting position from the impact surface 30 of the sleeve 25 by a gap 32. The width 28 of the gap 32, i.e., the distance of the impact surface 30 of the sleeve 25 from the abutment surface 31 of the core 26, is equal to the possible course 28 of the core 26 in the percussion element 14.

The percussion element 14 has a spring element 33. The spring element 33 is clamped between the sleeve 25 and the core 26 along the working axis 11. The spring element 33 holds the core 26 in the starting position with respect to the sleeve 25. The core 26 abuts on the rear stop, e.g., on the snap ring 29. The spring element 33 is, for example, an O-ring made from synthetic rubber or a leaf spring stack. The spring element 33 is offset to the impact surface 30 and to the abutment surface 31. The spring element 33 counteracts an impact of the abutment surface 31 on the impact surface 30 with a force, however, allows the impact in the case of a force that is exerted sufficiently. A cross-section diameter of the exemplary O-ring 33 is greater than three times the course 28.

When the percussion element 14 impacts the anvil 19 or the tool 4, the sleeve 25 transfers its impulse virtually instantaneously to the anvil 19 or the tool 4. The core 26 initially compresses the spring element 33 upon impact (see lower half of image of FIG. 2) before the core 26 impacts the sleeve 25 and transfers its impulse indirectly to the anvil 19 via the sleeve 25. The associated delay causes a longer lasting transfer of the impact energy which proves to be advantageous. The course 28 relevant for doing so, or width 28 of the gap 32, is preferably in the range of 0.3 mm to 1.5 mm.

The mass of the percussion element 14 is substantially composed of the mass of the core 26 and the mass of the sleeve 25. The core 26 and the sleeve 25 contribute with at least 25% respectively to the mass of the percussion element 14.

FIG. 3 shows the percussion mechanism 6 with a percussion element 14 facing away. The percussion element 14 has a sleeve 34, a core 35 moveable in the sleeve 34 along the working axis 11 and a spring element 33.

The core 35 forms the percussion surface 23 of the percussion element 14. The core 35 has an inner impact surface 36 pointing counter to the percussion direction 12, on which an opposing abutment surface 37 of the sleeve 34 can impact. The sleeve 34 is enclosed by the core 35 along the working axis 11 whereby a course 28 of the sleeve 34 is delimited with respect to the core 35. The front stop of the enclosure is formed by the impact surface 36 and the abutment surface 37. The spring element 33 drives the sleeve 34 into the rear stop whereby the impact surface 30 is distanced from the abutment surface 31 by a gap 38. The width 28 of the gap 38 corresponds to the course 28. The course 28 is in the range of between 0.3 mm and 1.5 mm. The sleeve 34 and the core 35 respectively contribute to at least 25% of the mass of the percussion element 14. The mass of the sleeve 34 and core 35 is preferably different by at least 50%.

The sleeve 34 forms the sliding surface 21 of the percussion element 14 which guides the percussion element 14 in the guide tube 15 along the working axis 11. The sleeve 34 has a cylindrical or prismatic section of the inner surface 27. The inner surface 27 also has a radial step or shoulder 39 with the abutment surface 37 pointing in the percussion direction 12. The abutment surface 37 is circular, preferably aligned coaxial to the working axis 11.

The core 35 forms the outer percussion surface 23 of the percussion element 14 which impacts the anvil 19. The core 35 has a cylindrical or prismatic sliding surface 40 which is guided by the inner surface 27 of the sleeve 34 parallel to the working axis 11. The core 35 has a radial step or shoulder 41 which is arranged behind the shoulder 39 of the sleeve 34 in the percussion direction 12. The shoulder 41 of the core 35 forms an impact surface 36 which is located opposite the abutment surface 37 of the sleeve 34.

The exemplary core 35 is composed of two components 42, 43. The front monolithic component 42 forms the percussion surface 23 and the impact surface 30. The rear component 43 forms the rear stop for the sleeve 34. The rear component 43 is for example a disc which overlaps radially with the sleeve 34. A damping element 44, e.g., an O-ring, can be arranged between the rear component 43 and the sleeve 34. The two components 42, 43 can be screwed together. The two components contribute to the mass of the core 35.

The spring element 33 is arranged offset to the impact surface 36 and the abutment surface 37. The exemplary core 35 has a second radial step 45 with a surface 46 pointing counter to the percussion direction 12; the sleeve 34 has a second radial step 47 whose surface 48 pointing in the percussion direction is located opposite the surface 46. The distance of the two surfaces 48, 46 is preferably greater than the course 28, preferably more than three times greater than the course 28. The spring element 33, e.g., the O-ring, is clamped between the two surfaces 48, 46.

The exciter 13 can be designed as a cylindrical piston. In one alternative configuration of the percussion mechanism 6, the guide tube is rigidly connected with the exciter piston 13 to an exciter. The exciter piston and the guide tube move together along the working axis 11. The percussion element 14 is guided in the guide tube along the working axis 11 and is coupled by the pneumatic chamber 18 to the movement of the exciter.

1.-7. (Canceled)

8. A power tool, comprising:
a tool holder for holding a chiseling tool on a working axis;
a motor; and
a pneumatic percussion mechanism, wherein the pneumatic percussion mechanism includes a percussion element guided on the working axis and having a percussion surface pointing in a percussion direction, an exciter piston drivable by the motor, and a pneumatic chamber formed between the exciter piston and the percussion element for coupling the percussion element to a movement of the exciter piston;
wherein the percussion element has a first partial body that forms the percussion surface, a second partial body, and a spring element, wherein the first partial body is movable along the working axis relative to the second partial body, and wherein the second partial body has an abutment surface pointing in the percussion direction;
wherein the first partial body has an impact surface opposite the abutment surface for receiving an abutment of the second partial body on the first partial body;
wherein the spring element drives the first partial body relative to the second partial body in the percussion direction into a starting position in which the abutment surface is separated from the impact surface by a gap.

9. The power tool according to claim 8, wherein the gap has a width of between 0.3 mm to 1.5 mm.

10. The power tool according to claim 8, wherein the first partial body and the second partial body each have a proportion of at least 25% of a mass of the percussion element.

11. The power tool according to claim 8, wherein the first partial body is a sleeve and the second partial body is a core movable in the sleeve.

12. The power tool according to claim 8, wherein the second partial body is a sleeve and the first partial body is a core movable in the sleeve.

13. The power tool according to claim 8, wherein the spring element is disposed offset to the abutment surface and to the impact surface.

14. The power tool according to claim 8, wherein the second partial body is enclosed in the percussion element along the working axis such that a movement of the second partial body with respect to the first partial body is limited to a course that is equal to a width of the gap.
